(19) United States
(12) Patent Application Publication
(10) Pub. No.: US 2004/0213394 A1
(43) Pub. Date: Oct. 28, 2004

(54) Method and network transition nodes for transmitting extended control information from a first communication network to a second communication network connected to the first

(76) Inventors: Andreas Lang, Erding (DE); Klaus Niegle, Landsberg am Lech (DE); Alfred Schneider, Haar (DE)

Correspondence Address: MORRISON & FOERSTER LLP, 1650 TYSONS BOULEVARD, SUITE 300, MCLEAN, VA, 22102, US

(21) Appl. No.: 10/478,440

(22) PCT Filed: May 10, 2002
(86) PCT No.: PCT/DE02/01696

(30) Foreign Application Priority Data
May 22, 2001 (DE) 10125057.6

(51) Int. Cl. H04L 12/56; H04L 12/28; H04M 7/00; H04M 3/42

(52) U.S. Cl. 379/201.01; 379/219; 370/401

(57) ABSTRACT

After receipt of the expanded control information coming from the first communications network, the following steps are carried out in a network transition node connected to a further communications network: Based on the telephone number of the caller, which is transmitted with the control information, data for controlling functions are assigned, which are valid for the further communications network and which functionally correspond with the data for controlling functions of the first communications network, and the data for controlling functions, which are assigned to the telephone number of the caller, are added to the control information, the control information with the data for controlling functions assigned to the telephone number of the caller being transmitted to the further communications network.

### TECHNICAL FIELD OF THE INVENTION

The invention relates to a method for the transmission of expanded control information from a first communications network to a further communications network, which is connected to the first communications network, and a network transition node.

### BACKGROUND OF THE INVENTION

Communications networks are currently provided by various network operators. Previously, in the transmission of expanded control information for the signaling of calls or for requesting services such as, for example, distributed groups of subscriber connections beyond network limits (Centrex=CENTRAL Office EXchange, business groups), the transportation of data or parameters for controlling functions, in particular of subscriber-specific data such as, for example, of a Centrex group identification (Centrex=private exchange function implemented in a central exchange) or callback in the case of no reply when transferring between two communications networks from different network operators, was not supported. In such cases, the expanded control information, which contains information on services or subscriber profiles, is transmitted additionally for signaling a call. The data or parameters for controlling functions are logically assigned to the subscriber who has initiated the signaling of the call or request for service. If the subscriber who initiated the signaling of the call, also referred to as the caller, is, however, not a subscriber of the communications network to which the call or request for service is to be transferred at the network transition node, then the data for controlling functions are either suppressed, cut off or provided with new values when transferred between networks. The consequence of this is that the subscriber-specific functions or services, which are available within a communications network for the call or for the request of services, e.g. the Centrex identification or the indication that callback in the case of no reply is possible at the network transition to a further communications network of a different network operator, are lost and therefore cannot be used.

### SUMMARY OF THE INVENTION

According to an aspect of the invention, subscriber profiles or services represented by the data for controlling functions can be used beyond network limits between the communications networks of different network operators.

According to another aspect of the invention, in the network transition node, which connects at least two communications networks of different network operators, based on the telephone number of the caller, which is transmitted with the expanded control information for a call or for a request for service, data for controlling functions is assigned. The data is valid for a further communications network, which is provided by a network operator that is different from the network operator of the first communications network, and which functionally corresponds with the data for controlling functions of the first communications network. The data for controlling functions, which is assigned to the telephone number of the caller, is then added to the control information that is transmitted to the further communications network.

In order to be able to implement the assignment between telephone numbers and data for controlling functions, a mapping between the telephone numbers of the subscribers belonging to the first communications network of a network operator and the required data for controlling functions has to be administered in the network transition node by the network operator of the further communications network to which the control information is to be transmitted or forwarded. In doing so, the data for controlling functions that is also valid in the further communications network, should functionally correspond to the data for controlling functions, which is provided by the network operator in the first communications network. This means that if the data for controlling functions in the first communications network represents a particular service or a particular subscriber profile, e.g. a particular Centrex group identification, then the data for controlling functions that are added for the further communications network must represent the same services and subscriber profiles, e.g. the same Centrex group identification.

In this way, it is ensured that the services or subscriber profiles that are provided to the subscriber in a first communications network are maintained beyond network limits.

In this regard, it is noted that the mapping between the telephone numbers and the data for controlling functions should be symmetrical. In other words, the network operator of the first communications network must administer an appropriate mapping between the telephone numbers of the subscribers belonging to the further communications network and the corresponding data for controlling functions in the network transition node. For the subscribers belonging to the first communications network, the same services or subscriber profiles are therefore maintained across the networks as would otherwise only have been available internally within a communications network.

### BRIEF DESCRIPTION OF THE DRAWING

FIG. 1 illustrates the communications networks according to the invention.

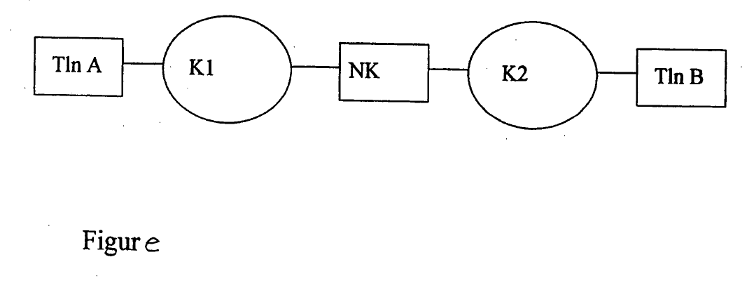

### DETAILED DESCRIPTION OF THE INVENTION

By way of an example, a call is initiated from subscriber connection Tln A to subscriber connection Tln B. In this case, subscriber connections Tln A and Tln B belong, for example, to a common Centrex group. Accordingly, in order to set up a communications connection between Tln A and Tln B via the communications network K1, control information that contains both the telephone number of the subscriber connection Tln A as well as Centrex data for controlling functions, e.g. the Centrex group identification, is transmitted to the network transition node NK. A mapping of the communications network K2, which is administered by the second network operator, e.g. in the form of a table in a database, in which data for controlling functions that are valid in the further communications network K2, are assigned to the telephone numbers of the subscriber connections belonging to the first communications network K1, is provided in the network transition node NK. In the example, the telephone number of the subscriber connection Tln A is assigned to a particular Centrex group identification. This Centrex group identification, to which the second network operator of the communications network K2 can assign a different scheme of numbering of Centrex group identification from that of the first network operator, must, however, fulfill the same function as the Centrex group identification contained in the control information transmitted to the network transition node.

After this assignment, the control information, to which the assigned data for controlling functions (e.g. Centrex group identification) have been added, is transmitted from the network transition node NK onward to the communications network K2 and, from there, if necessary, is forwarded to the subscriber connection Tln B, if this is required for the control of the function (e.g. the Centrex group service).

A similar method of procedure is also conceivable for transmission of control information from subscriber connection Tln B in the direction of subscriber connection Tln A. In this case, it is necessary for the first network operator of the communications network K1 to provide an appropriate mapping between the telephone number of the subscriber connection Tln B and the data for controlling functions for the communications network K1 in the network transition node NK.

The following examples of data for controlling functions to which the invention can be applied are conceivable:

Signaling point code: address of an exchange within the signaling network.

Business Group Identification: number that identifies the different groups distributed across the networks, e.g. 1=first company, 2=second company, 3=third company).

VPN (VPN=virtual private network) Transport Query on release: information that the telephone number called is no longer on the network but has changed to a different network operator. The new address, at which the number is now to be found, must be queried in a central database.

CCNR possible: callback if no reply. The system automatically sets up a connection to the caller when the subscriber to be called is contactable again.

Subscriber-subscriber signaling: a certain amount of data can be transmitted from one subscriber to another, along with a call, without having to set up a separate data connection.

SPV (SPV=semi-permanent connection).

1TR6 transparency: 1TR6 protocol is an ISDN protocol for the Deutsche Telekom D-channel (TR=Technical Directive).

Method and network transition node for the transmission of expanded control information from a first communications network to a further communications network, which is connected to the first

The invention relates to a method for the transmission of expanded control information from a first communications network to a further communications network, which is connected to the first, as claimed in the preamble of patent claim 1, and a network transition node as claimed in the preamble of patent claim 4.

These days, communications networks are provided by various network operators. Previously, in the transmission of expanded control information for the signaling of calls or for requesting services such as, for example, distributed groups of subscriber connections beyond network limits (Centrex=CENTRAL Office EXchange, business groups), the transportation of data or parameters for controlling functions, in particular of subscriber-specific data such as, for example, of a Centrex group identification (Centrex=private exchange function implemented in a central exchange) or callback in the case of no reply when transferring between two communications networks from different network operators, was not supported. In such cases, the expanded control information, which contains information on services or subscriber profiles, is transmitted additionally for signaling a call. The said data or parameters for controlling functions are logically assigned to the subscriber who has initiated the signaling of the call or request for service. If the subscriber who initiated the signaling of the call, also referred to as the caller, is, however, not a subscriber of the communications network to which the call or request for service is to be transferred at the network transition node, then the data for controlling functions are either suppressed, cut off or provided with new values when transferred between networks. The consequence of this is that the subscriber-specific functions or services, which are available within a communications network for the call or for the request of services, e.g. the Centrex identification or the indication that callback in the case of no reply is possible at the network transition to a further communications network of a different network operator, are lost and therefore cannot be used.

The object of the invention consists in that the subscriber profiles or services represented by the data for controlling functions can be used beyond network limits between the communications networks of different network operators.

With regard to a method, the problem is solved by the characteristics of patent claim 1 and, with regard to a device, by the characteristics of patent claim 4. Advantageous embodiments of the invention are specified in further patent claims.

A significant aspect of the invention consists in that, in the network transition node, which connects at least two communications networks of different network operators, based on the telephone number of the caller, which is transmitted with the expanded control information for a call or for a request for service, data for controlling functions are assigned, which are valid for a further communications network, which is provided by a network operator that is different from the network operator of the first communications network, and which functionally correspond with the data for controlling functions of the first communications network. These data for controlling functions, which are assigned to the telephone number of the caller, are then added to the control information that is transmitted to the further communications network.

In order to be able to implement the said assignment between telephone numbers and data for controlling functions, a mapping between the telephone numbers of the subscribers belonging to the first communications network of a network operator and the required data for controlling functions has to be administered in the network transition node by the network operator of the further communications network to which the control information is to be transmitted or forwarded. In doing so, the data for controlling functions that is valid in the further communications network, should functionally correspond to the data for controlling functions, which is provided by the network operator in the first communications network. This means that if the data for controlling functions in the first communications network represent a particular service or a particular subscriber profile, e.g. a particular Centrex group identification, then the data for controlling functions that are added for the further communications network must represent the same services and subscriber profiles, e.g. the same Centrex group identification.

In this way, it is ensured that the services or subscriber profiles that are provided to the subscriber in a first communications network are maintained beyond network limits.

In this regard, it must be noted that the mapping between the telephone numbers and the data for controlling functions should be symmetrical. Expressed in other words, the network operator of the first communications network must administer an appropriate mapping between the telephone numbers of the subscribers belonging to the further communications network and the corresponding data for controlling functions in the network transition node. For the subscribers belonging to the first communications network, the same services or subscriber profiles are therefore maintained across the networks as would otherwise only have been available internally within a communications network.

The invention is explained in more detail below by means of an exemplary embodiment based on a diagram.

The figure schematically shows a first communications network K1, e.g. a telephone network, which is provided by a first network operator, and a further communications network K2, which is connected to the first by means of a network transition node NK and which is provided by a second network operator. The first communications network K1 has several subscriber connections, e.g. a subscriber connection Tln A connected to the communications network K1. The further communications network K2 also has several subscriber connections, e.g. a subscriber connection Tln B connected to the communications network K2.

By way of an example, a call is initiated from subscriber connection Tln A to subscriber connection Tln B. In this case, subscriber connections Tln A and Tln B belong, for example, to a common Centrex group. Accordingly, in order to set up a communications connection between Tln A and Tln B via the communications network K1, control information that contains both the telephone number of the subscriber connection Tln A as well as Centrex data for controlling functions, e.g. the Centrex group identification, is transmitted to the network transition node NK. A mapping of the communications network K2, which is administered by the second network operator, e.g. in the form of a table in a database, in which data for controlling functions that are valid in the further communications network K2, are assigned to the telephone numbers of the subscriber connections belonging to the first communications network K1, is provided in the network transition node NK. In the example, the telephone number of the subscriber connection Tln A is assigned to a particular Centrex group identification. This Centrex group identification, to which the second network operator of the communications network K2 can assign a different scheme of numbering of Centrex group identification from that of the first network operator, must, however, fulfill the same function as the Centrex group identification contained in the control information transmitted to the network transition node.

After this assignment, the control information, to which the assigned data for controlling functions (e.g. Centrex group identification) have been added, is transmitted from the network transition node NK onward to the communications network K2 and, from there, if necessary, is forwarded to the subscriber connection Tln B, if this is required for the control of the function (e.g. the Centrex group service).

A similar method of procedure is also conceivable for a transmission of control information from subscriber connection Tln B in the direction of subscriber connection Tln A. In this case, it is necessary for the first network operator of the communications network K1 to provide an appropriate mapping between the telephone number of the subscriber connection Tln B and the data for controlling functions for the communications network K1 in the network transition node NK.

The following examples of data for controlling functions to which the invention can be applied are conceivable:

Signaling point code: address of an exchange within the signaling network

Business Group Identification: number that identifies the different groups distributed across the networks, e.g. 1=first company, 2=second company, 3=third company)

VPN (VPN=virtual private network) Transport Query on release: information that the telephone number called is no longer on the network but has changed to a different network operator. The new address, at which the number is now to be found, must be queried in a central database

CCNR possible: callback if no reply. The system automatically sets up a connection to the caller when the subscriber to be called is contactable again.

Subscriber-subscriber signaling: a certain amount of data can be transmitted from one subscriber to another, along with a call, without having to set up a separate data connection.

SPV (SPV=semi-permanent connection)

1TR6 transparency: 1TR6 protocol is an ISDN protocol for the Deutsche Telekom D-channel (TR=Technical Directive).

1-4. (canceled)

5. A method for setting up a connection from a first subscriber of a first communications network to a second communications network which is connected to the first communications network, comprising:
after receiving the expanded control information coming from the first communications network, assigning data for controlling functions, in a network transition node which connects the first and second communications networks, based on a telephone number of a caller which is transmitted with the expanded control information, whereby the assigned data for controlling functions is valid for the second communications network and is functionally equivalent to the data for controlling functions of the first communications network;
adding the data for controlling functions which is assigned to the telephone number of the caller to the expanded control information; and
transmitting the control information with the data for controlling functions assigned to the telephone number of the caller to the second communications network.

6. A method as claimed in claim 5, wherein the data for controlling functions represents a subscriber profile to a subscriber to which the transmitted telephone number of the caller is assigned.

7. A method as claimed in claim 5, wherein the data for controlling functions represents a request for services from a subscriber to which the transmitted telephone number of the caller is assigned.

8. A device for setting up a connection from a subscriber of a first communication network to a subscriber of a second communications network, comprising:
a network transition node between the first communications network and the second communications network, connecting the first and second communications networks, wherein
after receiving expanded control information coming from the first communications network, data for controlling functions is assigned, based on a telephone number of a caller which is transmitted with the control information, the data being valid for the second communications network and functionally corresponding to the data for controlling functions of the first communications network, and
after receiving the expanded control information, the assigned data for controlling functions is added to the control information in the network transition node, and together the assigned data and the expanded control information are transmitted to the second communications network.
